(19) United States
(12) Patent Application Publication
(10) Pub. No.: US 2022/0383350 A1
(43) Pub. Date: Dec. 1, 2022

(54) TRACKING USER ENGAGEMENT AND USER IMPRESSIONS

(71) Applicant: BWH TECHNOLOGIES PRIVATE LIMITED, Bengaluru (IN)

(72) Inventors: VENKATESAN KESHAVAN, DHARMAPURI (IN); MOHAMMAD YOUNUS BUDOO, Bangalore (IN); BAGEPALLI SESHANNA VEDAVAS, Bangalore (IN); MURALI KRISHNA KOLLA, Bangalore (IN)

(21) Appl. No.: 17/755,928

(22) PCT Filed: Nov. 12, 2020
(86) PCT No.: PCT/IN2020/050952

§ 371 Date: May 12, 2022

(30) Foreign Application Priority Data
Nov. 12, 2019 (IN) 201941045897

(51) Int. Cl. G06Q 30/02

(52) U.S. Cl. CPC G06Q 30/0205

(57) ABSTRACT

Aspects of the present disclosure are directed to determining user engagement index and tracking user impressions. According to an aspect, OTT content is provided to a user and the OTT content prompts interactions from the user. Such interactions of the user with the OTT content are tracked. The user engagement index is determined based on the tracked interactions. According to another aspect, one or more impressions are received from a second set of users, where the one or more impressions include one or more content items. The corresponding geographical locations of the second set of users are identified. It is determined that the one or more impressions correspond to one or more products or services provided by a first set of users. The one or more received impressions are tagged to the corresponding products or services, and the corresponding geographical locations of the second set of users.

### PRIORITY CLAIM

The instant patent application is related to and claims priority from the co-pending India provisional patent application entitled, “CONTEST TOOL FOR BRANDS AND SYSTEM FOR REAL TIME CUSTOMER VISIT DENSITY MAPPING”, Application No. 201941045897, Filed: 12 Nov. 2019, naming as inventors Venkatesan Keshavan et al, attorney docket number: BWH-301-INPR, which is incorporated in its entirety herewith.

### BACKGROUND OF THE DISCLOSURE

### Technical Field

The present disclosure relates to tracking user engagement and user impressions, more specifically to an interactive tool for tracking user engagement and user impressions.

### Related Art

User engagement refers to the level of user's interactions, over a period of time, with content provided by a content provider. User engagement is typically assessed based on the interactions of the users with the content, such as click-throughs, screen time etc.

User impressions refer to opinion/feedback of users on products and services. Products and services also include content and content services. Impressions can be represented in the form of text content, audio content, visual content, audio-visual content etc.

Tracking user engagement and user impressions aids providers of the products and services in decision making. Aspects of the present disclosure are directed to tracking user engagement and user impressions.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which user engagement is tracked.

FIGS. 3A-3C depict sample user interfaces provided to users, prompting interactions from the users.

FIG. 4 is a flow chart illustrating the manner in which user impressions are tracked.

FIGS. 5A-5E depict sample user interfaces provided to users for receiving and tracking user impressions.

FIG. 6 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

1. Overview

Aspects of the present disclosure are directed to an interactive tool for tracking user engagement and user impressions.

According to an aspect, determination of user engagement index at an over-the-top (OTT) content provider server system is disclosed. In an embodiment, OTT content is provided to a user and the OTT content prompts interactions from the user. Such interactions of the user with the OTT content are tracked. The user engagement index is determined based on the tracked interactions.

According to another aspect, tracking of user impressions at a server system is disclosed. In an embodiment, one or more impressions are received from a second set of users, where the one or more impressions include one or more content items. The corresponding geographical locations of the second set of users are identified. It is determined that the one or more impressions correspond to one or more products or services provided by a first set of users. The one or more received impressions are tagged to the corresponding products or services, and the corresponding geographical locations of the second set of users.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

2. Example Environment

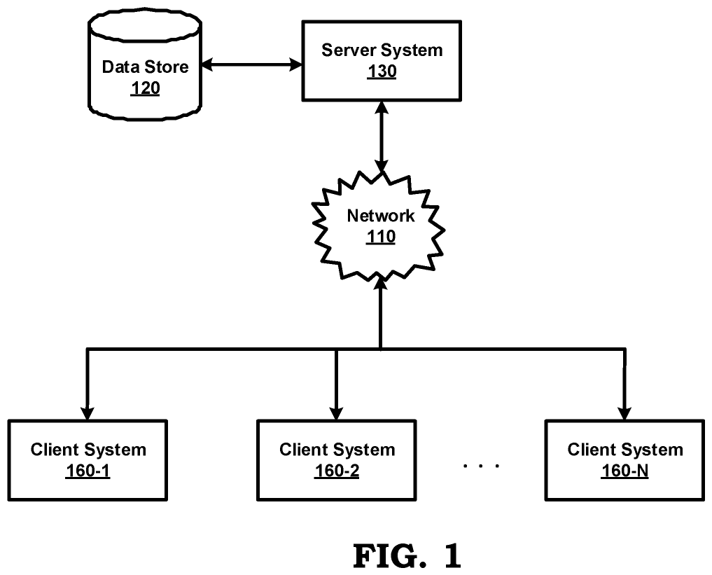

FIG. 1 is a block diagram illustrating an example environment in which several aspects of the present disclosure can be implemented. The block diagram is shown containing network 110, data store 120, server system 130 and client systems 160-1 to 160-N (N representing any arbitrary positive number). Client systems 160-1 to 160-N are collectively or individually referred by referral numeral 160, as will be clear from the context.

Merely for illustration, only representative number/type of systems are shown in FIG. 1. Many environments often contain many more systems, both in number and type, depending on the purpose for which the environment is designed. Each block of FIG. 1 is described below in further detail.

Network 110 provides connectivity between client systems 160-1 to 160-N and server system 130, and may be implemented using protocols such as Transmission Control Protocol (TCP) and/or Internet Protocol (IP), well-known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered.

An IP packet is said to be directed to a target system when the destination IP address of the packet is set to the IP address of the target system, such that the packet is eventually delivered to the target system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of a collection of data by server system 130. Data store 120 may be implemented as a database server using relational database technologies and accordingly provide storage and retrieval of data using structured queries such as SQL (Structured Query Language). Alternatively or in addition, data store 120 may be implemented as a file server providing storage and retrieval of data in the form of files organized as one or more directories, as is well-known in the relevant arts.

Each of client systems 160-1 to 160-N represents a corresponding end user system such as a personal computer, workstation, mobile station, mobile phones, computing tablets, etc. used by end users to access content from server system 130. In general, client system 160 sends user requests for accessing (reading/writing) the content and may receive the corresponding responses (e.g., embedded in web pages) providing the access. The web pages/responses may then be presented to the user at client systems 160 by client applications such as the browser.

Server system 130 represents a central server such as a web/application/content server, executing one or more software applications. Server system 130 may aid client systems in accessing the content. In an embodiment, server system 130 operates to provide a web application/portal for providing access to the content.

Server system 130 receives a user request from a client system 160 and provides access to the content requested (in the user request). Server system 130 may use data stored internally (for example, in a non-volatile storage/hard disk within the server), external data (e.g., maintained in data store 120) and/or data received from external sources (e.g., from the user) in providing access to the requested content. Server system 130 provides access to the requested content as a corresponding response (e.g., embedded in web pages) to the user request. In an embodiment, server system 130 also maintains a log of the contents accessed by client system 160 i.e., contents read from/written onto server system 130.

In another embodiment, server system 130 is an over-the-top (OTT) content provider server system that provides access to streaming content via the internet.

In embodiments described below, server system 130 is assumed to operate based on machine learning and artificial intelligence capabilities.

The manner in which tracking of user engagement and user impressions is implemented is explained below.

3. Flowchart Illustrating the Manner in Which User Engagement Index is Determined

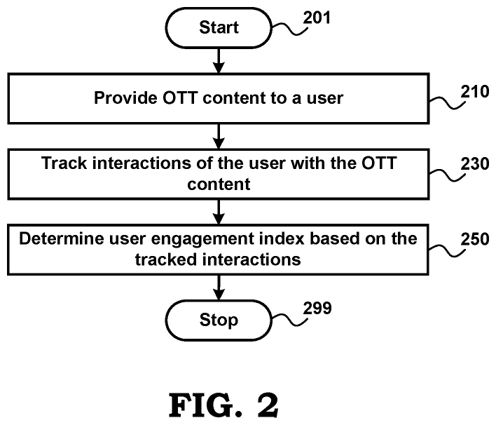

FIG. 2 is a flowchart illustrating the manner in which user engagement index is determined according to an aspect of the present disclosure. The flowchart is described with respect to the systems of FIG. 1 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure.

The flow chart begins in step 201, in which control immediately passes to step 210.

In step 210, server system 130 provides OTT content to a user of client system 160. The OTT content is streamed directly to the user via internet. The OTT content may include audio, visual or audio-visual content. In an embodiment, the OTT content may prompt interactions from the user. The prompted interactions may be in the form of click-throughs on the content, audio/voice messages or in any other form as would be readily apparent to a skilled practitioner.

Server system 130 may also maintain the log of the OTT content(s) provided to the user. In an example embodiment, the log includes details such as name/id of the content provided to the user, time stamp at which the content is provided etc. The Control passes to step 230.

In step 230, server system 130 tracks the interactions of the user with the OTT content provided by server system 130. In an embodiment, the OTT content may dynamically change based on the interactions of the user. In an example embodiment, tracking includes logging the interactions of the user such as the name/id of the content before an interaction, time stamp at which the content prompted the interaction, time stamp at which the interaction is received from the user, content displayed to the user after the interaction. Server system 130 may calculate the time periods between the successive interactions with the OTT content and the total duration of the interactions with the OTT content based on such logs.

In step 250, server 130 determines the user engagement index based on the tracked interactions of the user. In an example embodiment, the user engagement index is determined based on (i) the time periods between the successive interactions with the OTT content and (ii) the total duration of the interactions with the OTT content.

The flowchart ends in step 299.

In an example embodiment where the interactions are in the form of audio/voice, client system 160 converts the audio/voice messages of the user into electrical signals for processing by server system 130.

In another example embodiment, the OTT content is a visual content corresponding to one or more products or services. In another example embodiment, the OTT content is in the form of a contest or game that prompts/requires responses from the user, and the user provides responses through the interactions with the content. In yet another example embodiment, the tracking includes analyzing of the responses and determining the user engagement index based on the analysis. In another example embodiment, the contest or game specifies eligibility criteria for participating in the contest/game, corresponding time periods within which responses are to be received etc.

Thus, the flowchart of FIG. 2 operates to determine user engagement index.

The above noted features/embodiments may be implemented using techniques well known in the relevant arts.

The description is continued with respect to the sample user interfaces provided by server system 130 to implement the method described in Flow chart of FIG. 2.

4. User Interfaces Illustrating Interactions from Users

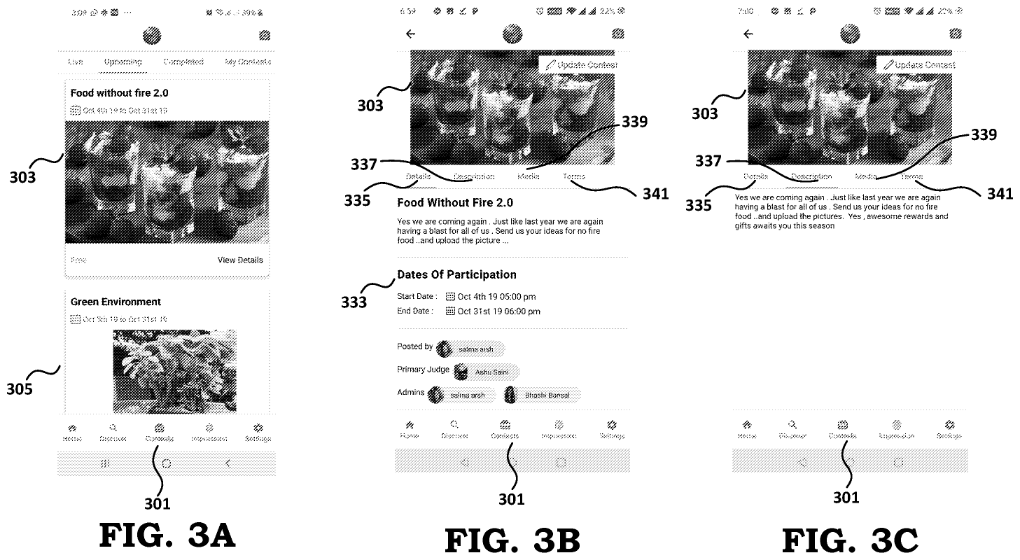

FIGS. 3A-3C depict sample user interface provided by server system 130 to users, prompting interactions from the users.

FIG. 3A depicts a sample user interface of the content provided by server system 130 to the users, prompting interactions from the users. In the sample user, the content is in the form of contests. Server system 130 provides multiple contests under item contests 301. When item contests 301 is selected (i.e., interacted with the content), server system 130 provides the details of various contests to the users, as indicated as items 303 and 305. As may be readily observed from FIG. 3A, items 303 and 305 also indicate the starting date/time and ending date/time of the corresponding contests. When a user selects item 303, server system 130 provides the sample user interface depicted in FIG. 3B.

The sample user interface of FIG. 3B is shown containing items dates of participation 333, details 335, description 337, media 339 and terms 341. Item dates of participation 333 indicates the dates/time for which the contest is open. Item details 335 provides the details of the contest, item description 337 provides the description about the contest (see sample interface of FIG. 3C), item media 339 allows the users to upload their media, item terms 341 show the terms and contains of the contest. The sample user interface of FIG. 3B is also shown depicting other details such the person(s) who created the contest, the judges of the contest, admins of the contest etc.

Thus, server system 130 provides content prompting interactions from the users and the content dynamically changes based on the interactions received from the users.

The description is continued with respect to the manner in which tracking of user impressions is implemented.

5. Flowchart Illustrating Tracking of User Impressions

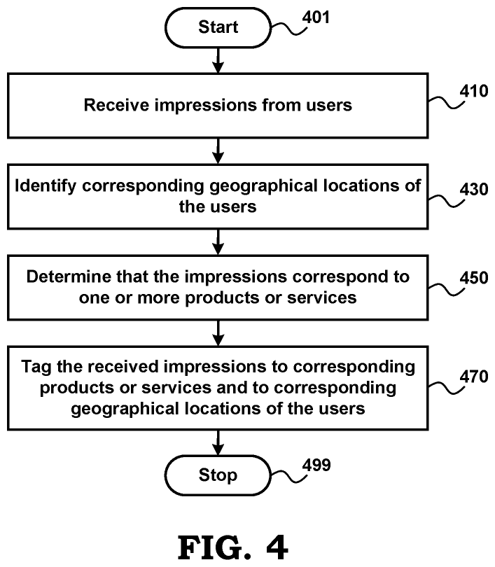

FIG. 4 is a flowchart illustrating the manner in which user impressions are tracked according to an aspect of the present disclosure. The flowchart is described with respect to the systems of FIG. 1 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure.

The flow chart begins in step 401, in which control immediately passes to step 410.

In step 410, server system 130 receives impressions from users (via client systems 160). Impressions indicate opinion/feedback of the users on products or services. Impressions may be received in the form of content items such as text content, audio content, visual content, audio-visual content, or in any other form as would be readily apparent to a skilled practitioner.

In step 430, server system 130 identifies corresponding geographical locations of the users. In an example embodiment, server system 130 maintains (for example, in data store 120) corresponding profiles of the users, including the corresponding geographical location of the users, and server system 130 identifies the corresponding geographical locations of the users (from whom impressions are received) based on the profile information. Control passes to step 450.

In step 450, server system 130 determines that the impressions correspond to one or more products or services provided by another set of users (providers). In an embodiment, server system may make such determination based on the tags or description associated with the received impressions. In another embodiment, server system may make such determination based on the user interfaces (such as user interface related to corresponding products/services). Control passes to step 470.

In step 470, server system 130 tags the received impressions to the corresponding products or services and the corresponding geographical locations of the users from whom the impressions are received. Such tagging of the received impressions allows to track the impressions as explained below.

The flowchart ends in step 499.

In an embodiment, server system 130 may determine that the received impressions are related to the products or services provided at a particular retail store, and may tag the impression to the retail store.

In another embodiment, server system 130 may provide a user interface indicating various retail stores located at various geographical locations, allow a selection of a retail store, and may display the impressions tagged to the selected retail store.

In yet another embodiment, server system 130 may provide an option to search and filter the impressions tagged to the selected retail store based on the geographical locations to which the one or more impressions are tagged. Server system 130 may also calculate density of the impressions tagged to the selected retail store in a particular geographical location. In an example embodiment, the density of impressions is calculated based on the number of impressions in a particular geographical location. A high density may indicate high footfall to that retail store, and thus may aid the provider to suitable decisions.

In yet another embodiment, server system 130 provides an option (to all the users/providers) to network with the users from whom the tagged impressions are received.

In yet another embodiment, server system 130 may restrict some of the embodiments noted above to specific users such as providers of the products or services.

The above noted features/embodiments may be implemented using techniques well known in the relevant arts.

Thus, the flowchart of FIG. 4 operates to provide a method for tracking user impressions. The description is continued with respect to the sample user interfaces provided by server system 130 to implement the method described in Flow chart of FIG. 4.

6. User Interfaces Illustrating Tracking of User Impressions

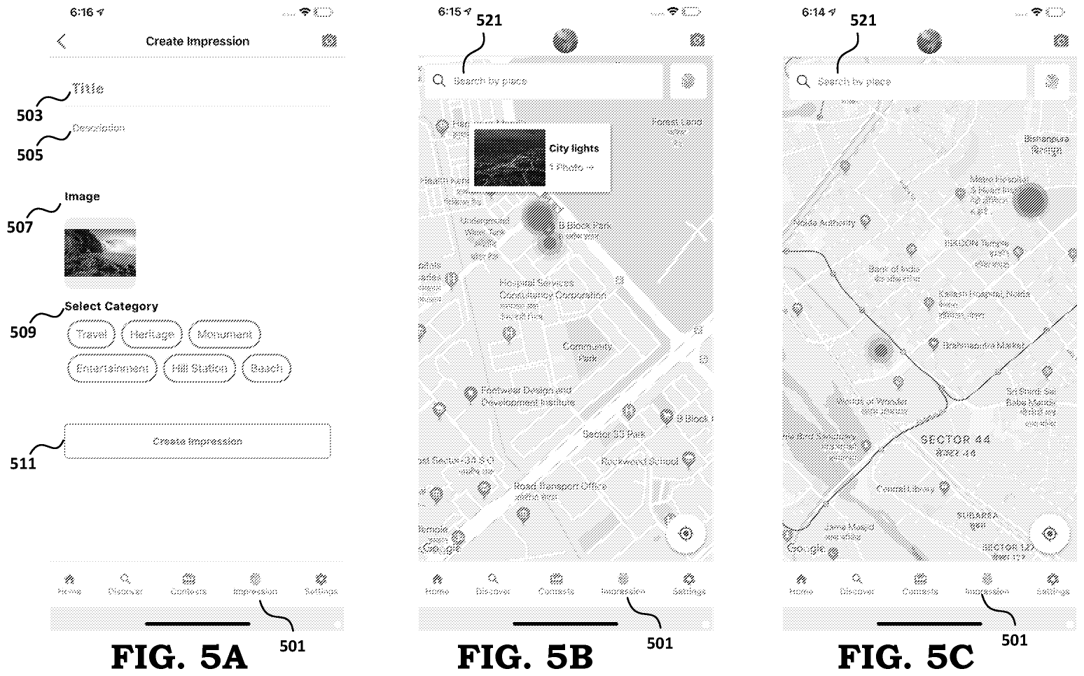

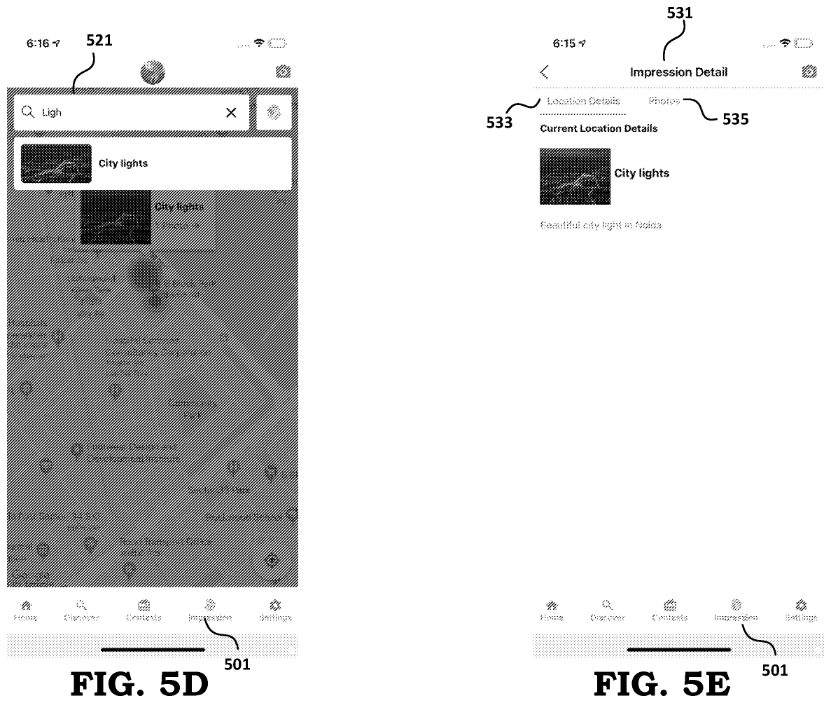

FIGS. 5A-5E depict sample user interfaces provided by server system 130 to users.

FIG. 5A depicts a sample user interface provided by server system 130 for receiving impressions from users. When user selects item impression 501, server system 130 provides items title 503, description 505, image 507, select category 509, create impression 511.

When a user enters the details required in items title 503, description 505, image 507 and select category 509, and selects item create impression 511, server system 130 creates an impression and tags it to the corresponding geographical location of the user/retail store (as depicted in FIG. 5B). Server system 130 determines the corresponding product or service based the information received items 503, 505, category 509.

FIG. 5B depicts a sample user interface depicting an impression tagged to a particular geographical location. FIG. 5C depicts a sample user interface depicting all the impressions tagged to a particular geographical location. FIG. 5D depicts a sample user interface depicting the search feature explained above. FIG. 5E depicts a sample user interface depicting how impressions of other users can be viewed.

In this manner server system 130 operates to determine user engagement index and track user impressions. Such determination of the user engagement index and the tracking of user impressions help the providers of the products and services in decision making.

It should be further appreciated that the features described above can be implemented in various embodiments as a desired combination of one or more of hardware, software, and firmware. The description is continued with respect to an embodiment in which various features are operative when the software instructions described above are executed.

7. Digital Processing System

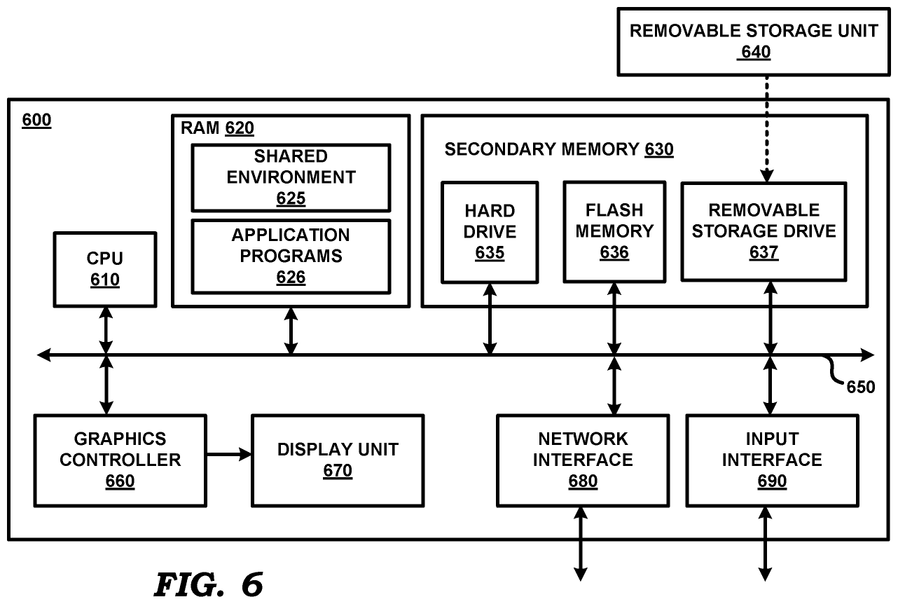

FIG. 6 is a block diagram illustrating the details of digital processing system 600 in which various aspects of the present disclosure are operative by execution of appropriate executable modules. Digital processing system 600 may correspond to one of client system 160 and server system 130.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well-known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit. In addition, CPU 610 may be supported by CAM (content addressable memory) structures for examination of complex patterns.

RAM 620 may receive instructions from secondary memory 630 using communication path 650. RAM 620 is shown currently containing software instructions constituting shared environment 625 and/or other user programs 626 (such as sever system 130 or client system 160 shown in FIG. 1). In addition to shared environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images (e.g., images in depicted in FIGS. 3A-3C and FIGS. 5A-5E) defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (of FIG. 1) connected to the networks (110).

Secondary memory 630 may contain hard drive 635, flash memory 636, and removable storage drive 637. Secondary memory 630 may store the data (for example, images uploaded by user on server system 130, voice samples received from user, etc) and software instructions (for example, for implementing the various features of the present disclosure as shown in FIGS. 2 and 4, etc.), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

8. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

1. A method for determining user engagement index, the method being implemented at an over-the-top (OTT) content provider server system, the method comprising:
providing (210) OTT content to a user, wherein the OTT content prompts interactions from the user;
tracking (230) interactions of the user with the OTT content,
wherein the user engagement index is determined (250) based on the tracking.

2. The method of claim 1, wherein the OTT content is streamed directly to the user via internet, and
the OTT content dynamically changes based on the interactions from the user.

3. The method of claim 2, wherein the OTT content is a visual content corresponding to one or more products or services,
the OTT content includes a contest requiring responses from the user and the responses are received through the interactions of the user,
the tracking includes analyzing of the responses to the one or more contests, and
the user engagement index is determined based on the analysis of the responses received.

4. The method of claim 3, wherein the contest specifies eligibility criteria for participating in the contest, corresponding time periods within which responses are to be received.

5. The method of claim 2, wherein the tracking includes calculating the time periods between successive interactions, and the user engagement index is determined based on the time periods between the successive interactions and the total duration of the interactions with the OTT content.

6. A method of tracking user impressions, the method being implemented at a server system, the method comprising: receiving (410) one or more impressions from a second set of users, wherein the one or more impressions include one or more content items;
identifying (430) corresponding geographical locations of the second set of users;
determining (450) that the one or more impressions correspond to one or more products or services provided by a first set of users;
tagging (470) the one or more impressions received from the second set of users to the corresponding products or services provided by the first set of users and the corresponding geographical locations of the second set of users.

7. The method of claim 6, wherein the server system maintains corresponding profiles of the second set of users, the profiles including information on corresponding geographical locations of the second set of users, and
identification of the corresponding geographical location of a user of the second set of users is made based on the corresponding profile of the user of the second set of users maintained by the server system.

8. The method of claim 7, wherein the one or more impressions are related to the products or services provided at a particular retail store of a user of the first set of users,
the determining includes that the one or more impressions received from the second set of users correspond to one or more products or services provided by the user of the first set of users at the particular retail store, and
the tagging further includes tagging the one or more impressions received from the second set of users to the particular retail store based on the determination that the received impressions correspond to one or more products or services provided at the particular retail store.

9. The method of claim 8, further comprising:
providing a user interface indicating various retail stores located at various geographical locations;
allowing a selection of a retail store from the retail stores;
displaying the impressions tagged to the selected retail store.

10. The method of claim 9, further comprising:
providing an option to filter the impressions tagged to the selected retail store based on geographical locations to which the impressions are tagged; and
calculating density of the impressions tagged to the selected retail store in a particular geographical location.

11. The method of claim 10, further comprising:
providing an option to network with the corresponding second set of users from whom the tagged impressions are received.

12. An over-the-top (OTT) content provider server system (130) for determining user engagement index, the OTT content provider server system configured to:
provide OTT content to a user, wherein the OTT content prompts interactions from the user;
track interactions of the user with the OTT content,
wherein the user engagement index is determined based on the tracking.

13-15. (canceled)

16. The OTT content provider server system of claim 12, wherein the OTT content is streamed directly to the user via internet, and
the OTT content dynamically changes based on the interactions from the user.

17. The OTT content provider server system of claim 16, wherein the OTT content is a visual content corresponding to one or more products or services,
the OTT content includes a contest requiring responses from the user and the responses are received through the interactions of the user,
the tracking includes analyzing of the responses to the one or more contests, and
the user engagement index is determined based on the analysis of the responses received.

18. The OTT content provider server system of claim 17, wherein the contest specifies eligibility criteria for participating in the contest, corresponding time periods within which responses are to be received.

19. The OTT content provider server system of claim 16, wherein the tracking includes calculating the time periods between successive interactions, and the user engagement index is determined based on the time periods between the successive interactions and the total duration of the interactions with the OTT content.
